(19) United States
(12) Patent Application Publication
(10) Pub. No.: US 2018/0335212 A1
(43) Pub. Date: Nov. 22, 2018

(54) REDUNDANT ENDRAIL FOR COMBUSTOR PANEL

(71) Applicant: UNITED TECHNOLOGIES CORPORATION, Farmington, CT (US)

(72) Inventors: SAN QUACH, Southington, CT (US); JEFFREY T. MORTON, Manchester, CT (US)

(73) Assignee: UNITED TECHNOLOGIES CORPORATION, Farmington, CT (US)

(21) Appl. No.: 15/599,196

(22) Filed: May 18, 2017

(51) Int. Cl. F23R 3/00; F23R 3/42; F02C 7/18

(52) U.S. Cl. CPC F23R 3/002; F23R 3/42; F02C 7/18; F05D 2230/00; F05D 2240/35; F05D 2260/201; F05D 2220/32

(57) ABSTRACT

A combustor panel may include a body having an edge, a first endrail disposed along the edge of the body, and a second endrail disposed adjacent the first endrail, wherein a volume is defined between the first endrail and the second endrail. The first endrail may have a first height, measured from the body to a first tip of the first endrail, and the second endrail may have a second height, measured from the body to a second tip of the second endrail, wherein the first height is the same as the second height. The second endrail may include an endrail hole extending through the second endrail.

### FIELD

The present disclosure relates to gas turbine engines, and more specifically, to combustors of gas turbine engines.

### BACKGROUND

A gas turbine engine typically includes a fan section, a compressor section, a combustor section, and a turbine section. A fan section may drive air along a bypass flowpath while a compressor section may drive air along a core flowpath. In general, during operation, air is pressurized in the compressor section and is mixed with fuel and burned in the combustor section to generate hot combustion gases. The hot combustion gases flow through the turbine section, which extracts energy from the hot combustion gases to power the compressor section and other gas turbine engine loads. The compressor section typically includes low pressure and high pressure compressors, and the turbine section includes low pressure and high pressure turbines.

Combustors used in gas turbine engines rely on combustor panels as thermal shields and to guide combustion gases into the turbine. These combustor panels interface with hot combustion gases and are often susceptible to structural damage and/or oxidation caused by the high temperature of the combustion gases.

### SUMMARY

In various embodiments, the present disclosure provides a combustor panel that includes a body having an edge, a first endrail disposed along the edge of the body, and a second endrail disposed adjacent the first endrail. A volume may be defined between the first endrail and the second endrail.

In various embodiments, the first endrail has a first height, measured from the body to a first tip of the first endrail, and the second endrail has a second height, measured from the body to a second tip of the second endrail, wherein the first height is substantially the same as the second height. The second endrail defines an endrail hole extending through the second endrail, according to various embodiments. The endrail hole may be canted relative to the combustor panel. In various embodiments, the first endrail is solid and has a continuous surface. In various embodiments, a distance between the first endrail and the second endrail is between about 0.05 inches and about 1.0 inch. In various embodiments, a distance between the first endrail and the second endrail is between about 0.10 inches and about 0.50 inches.

Also disclosed herein, according to various embodiments, is a combustor of a gas turbine engine. The combustor may include a combustor shell and a combustor panel coupled to the combustor shell. The combustor panel may include a body having an edge, a first endrail disposed along the edge of the body, and a second endrail disposed adjacent the first endrail, wherein a volume is defined between the first endrail and the second endrail.

In various embodiments, an annular cooling cavity is defined between the combustor shell and the combustor panel, wherein a first gap between a first tip of the first endrail and the combustor shell is substantially the same as a second gap between a second tip of the second endrail and the combustor shell. In various embodiments, an impingement hole of the combustor shell is configured to deliver cooling air to a volume between the first endrail and the second endrail. In various embodiments, the combustor panel is a first combustor panel and the combustor further includes a second combustor panel coupled to the combustor shell adjacent the first combustor panel.

Also disclosed herein, according to various embodiments, is a method of manufacturing a combustor panel. The method may include forming a first endrail along an edge of a body of the combustor panel and forming a second endrail adjacent the first endrail. In various embodiments, the first endrail has a first height, measured from the body to a first tip of the first endrail, and the second endrail has a second height, measured from the body to a second tip of the second endrail, wherein the first height is substantially the same as the second height. In various embodiments, the method further includes forming an endrail hole extending through the second endrail.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

FIG. 1 illustrates a cross-sectional view of an exemplary gas turbine engine, in accordance with various embodiments;

FIG. 2 illustrates a cross-sectional view of a combustor of a gas turbine engine, in accordance with various embodiments;

FIG. 3 illustrates a perspective cross-sectional view of a combustor shell and a combustor panel, in accordance with various embodiments;

FIGS. 4A and 4B illustrate cross-sectional views of a combustor shell and adjacent combustor panels, in accordance with various embodiments; and

FIG. 5 is a schematic flowchart diagram of a method of assembling a gas turbine engine, in accordance with various embodiments.

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein without departing from the spirit and scope of the disclosure. Thus, the detailed description herein is presented for purposes of illustration only and not of limitation.

As used herein, “aft” refers to the direction associated with the exhaust (e.g., the back end) of a gas turbine engine. As used herein, “forward” refers to the direction associated with the intake (e.g., the front end) of a gas turbine engine.

A first component that is “radially outward” of a second component means that the first component is positioned at a greater distance away from the engine central longitudinal axis than the second component. A first component that is “radially inward” of a second component means that the first component is positioned closer to the engine central longitudinal axis than the second component. In the case of components that rotate circumferentially about the engine central longitudinal axis, a first component that is radially inward of a second component rotates through a circumferentially shorter path than the second component. The terminology “radially outward” and “radially inward” may also be used relative to references other than the engine central longitudinal axis. For example, a first component of a combustor that is radially inward or radially outward of a second component of a combustor is positioned relative to the central longitudinal axis of the combustor.

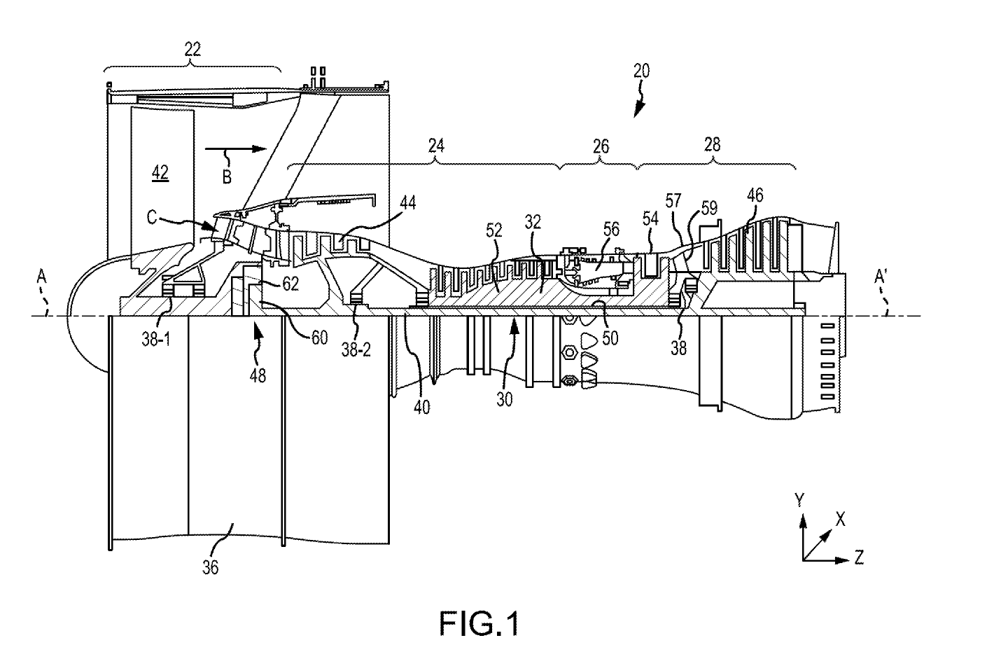

In various embodiments and with reference to FIG. 1, a gas turbine engine 20 is provided. Gas turbine engine 20 may be a two-spool turbofan that generally incorporates a fan section 22, a compressor section 24, a combustor section 26 and a turbine section 28. Alternative engines may include, for example, an augmentor section among other systems or features. In operation, fan section 22 can drive coolant (e.g., air) along a bypass flow-path B while compressor section 24 can drive coolant along a core flow-path C for compression and communication into combustor section 26 then expansion through turbine section 28. Although depicted as a turbofan gas turbine engine 20 herein, it should be understood that the concepts described herein are not limited to use with turbofans as the teachings may be applied to other types of turbine engines including three-spool architectures.

Gas turbine engine 20 may generally comprise a low speed spool 30 and a high speed spool 32 mounted for rotation about an engine central longitudinal axis A-A′ relative to an engine static structure 36 or engine case via several bearing systems 38, 38-1, and 38-2. Engine central longitudinal axis A-A′ is oriented in the z direction on the provided xyz axis. It should be understood that various bearing systems 38 at various locations may alternatively or additionally be provided, including for example, bearing system 38, bearing system 38-1, and bearing system 38-2.

Low speed spool 30 may generally comprise an inner shaft 40 that interconnects a fan 42, a low pressure compressor 44 and a low pressure turbine 46. Inner shaft 40 may be connected to fan 42 through a geared architecture 48 that can drive fan 42 at a lower speed than low speed spool 30. Geared architecture 48 may comprise a gear assembly 60 enclosed within a gear housing 62. Gear assembly 60 couples inner shaft 40 to a rotating fan structure. High speed spool 32 may comprise an outer shaft 50 that interconnects a high pressure compressor 52 and high pressure turbine 54.

A combustor 56 may be located between high pressure compressor 52 and high pressure turbine 54. The combustor section 26 may have an annular wall assembly having inner and outer shells that support respective inner and outer heat shielding liners. The heat shield liners may include a plurality of combustor panels that collectively define the annular combustion chamber of the combustor 56. An annular cooling cavity is defined between the respective shells and combustor panels for supplying cooling air. Impingement holes are located in the shell to supply the cooling air from an outer air plenum and into the annular cooling cavity.

A mid-turbine frame 57 of engine static structure 36 may be located generally between high pressure turbine 54 and low pressure turbine 46. Mid-turbine frame 57 may support one or more bearing systems 38 in turbine section 28. Inner shaft 40 and outer shaft 50 may be concentric and rotate via bearing systems 38 about the engine central longitudinal axis A-A′, which is collinear with their longitudinal axes. As used herein, a “high pressure” compressor or turbine experiences a higher pressure than a corresponding “low pressure” compressor or turbine.

The core airflow C may be compressed by low pressure compressor 44 then high pressure compressor 52, mixed and burned with fuel in combustor 56, then expanded over high pressure turbine 54 and low pressure turbine 46. Turbines 46, 54 rotationally drive the respective low speed spool 30 and high speed spool 32 in response to the expansion.

In various embodiments, geared architecture 48 may be an epicyclic gear train, such as a star gear system (sun gear in meshing engagement with a plurality of star gears supported by a carrier and in meshing engagement with a ring gear) or other gear system. Geared architecture 48 may have a gear reduction ratio of greater than about 2.3 and low pressure turbine 46 may have a pressure ratio that is greater than about five (5). In various embodiments, the bypass ratio of gas turbine engine 20 is greater than about ten (10:1). In various embodiments, the diameter of fan 42 may be significantly larger than that of the low pressure compressor 44, and the low pressure turbine 46 may have a pressure ratio that is greater than about five (5:1). Low pressure turbine 46 pressure ratio may be measured prior to inlet of low pressure turbine 46 as related to the pressure at the outlet of low pressure turbine 46 prior to an exhaust nozzle. It should be understood, however, that the above parameters are exemplary of various embodiments of a suitable geared architecture engine and that the present disclosure contemplates other gas turbine engines including direct drive turbofans. A gas turbine engine may comprise an industrial gas turbine (IGT) or a geared aircraft engine, such as a geared turbofan, or non-geared aircraft engine, such as a turbofan, or may comprise any gas turbine engine as desired.

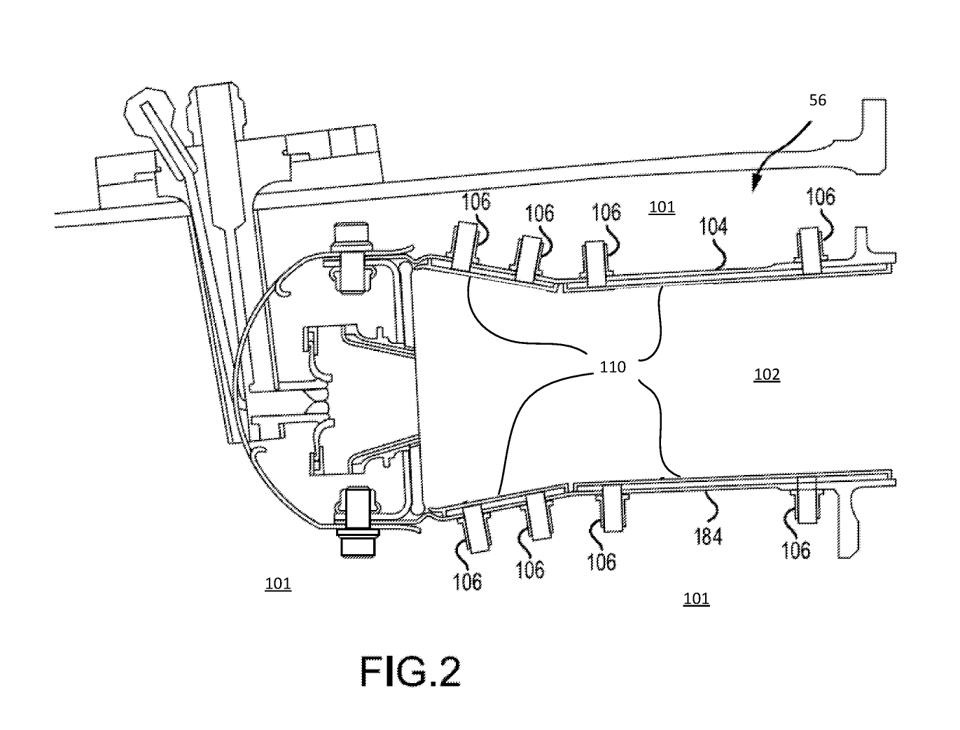

With reference to FIG. 2, an in accordance with various embodiments, one or more combustor panels 110 (e.g., thermal shields, combustor liners) may be positioned in combustor 56 to protect various features of the combustor 56 from the high temperature flames and/or combustion gases. The combustor 56, in various embodiments, may have a combustor chamber 102 defined by a combustor outer shell 104 and a combustor inner shell 184. A diffuser chamber 101 is external the combustor 56 and cooling air may be configured to flow through the diffuser chamber 101 around the combustor 56. The combustor chamber 102 may form a region of mixing of core airflow C (with brief reference to FIG. 1) and fuel, and may direct the high-speed exhaust gases produced by the ignition of this mixture inside the combustor 56. The combustor outer shell 104 and the combustor inner shell 184 may provide structural support to the combustor 56 and its components. For example, a combustor outer shell 104 and a combustor inner shell 184 may comprise a substantially cylindrical or a substantially conical canister portion defining an inner area comprising the combustor chamber 102.

As mentioned above, it may be desirable to protect the combustor outer shell 104 and the combustor inner shell 184 from the harmful effects of high temperatures. Accordingly, one or more combustor panels 110 may be disposed inside the combustor chamber 102 and may provide such protection. The combustor panels 110 may comprise a partial cylindrical or conical surface section. An outer combustor thermal panel may be arranged radially inward of the combustor outer shell 104, for example, circumferentially about the inner surface of the combustor outer shell 104 and one or more inner combustor panels may also be arranged radially outward of the combustor inner shell 184. The combustor panels 110 may comprise a variety of materials, such as metal, metal alloys, and/or ceramic matrix composites, among others

With continued reference to FIG. 2 and as mentioned above, the combustor panels 110 may be mounted and/or coupled to the combustor shell 104/184 via one or more attachment features 106. The combustor panels 110 may be made of any suitable heat tolerant material. In this manner, the combustor panels 110 may be substantially resistant to thermal mechanical fatigue in order to inhibit cracking of the combustor panels 110 and/or to inhibit liberation of portions of the combustor panels 110. In various embodiments, the combustor panels 110 may be made from a nickel based alloy and/or a cobalt based alloy, among others. For example, the combustor panels 110 may be made from a high performance nickel-based super alloy. In various embodiments, the combustor panels 110 may be made from a cobalt-nickel-chromium-tungsten alloy.

The one or more attachment features 106 facilitate coupling and/or mounting the combustor panels 110 to the respective shells 104, 184 of the combustor 56. In various embodiments, the attachment features 106 may be a boss or a stud extending radially relative to the combustor panels 110. In various embodiments, the attachment feature 106 is a cylindrical boss, such as a threaded pin, or may be a rectangular boss, such as for receiving a clip, or may be any other apparatus whereby the combustor panel 110 is mounted to the combustor outer shell 104 or the combustor inner shell 184. In various embodiments, the attachment feature 106 comprises a threaded stud that extends through a corresponding aperture in the combustor outer shell 104 or the combustor inner shell 184, and is retained in position by an attachment nut disposed outward of the combustor outer shell 104 and torqued so that the attachment feature 106 is preloaded with a retaining force and securely affixes the combustor panel 110 in a substantially fixed position relative to the combustor outer shell 104 or the combustor inner shell 184.

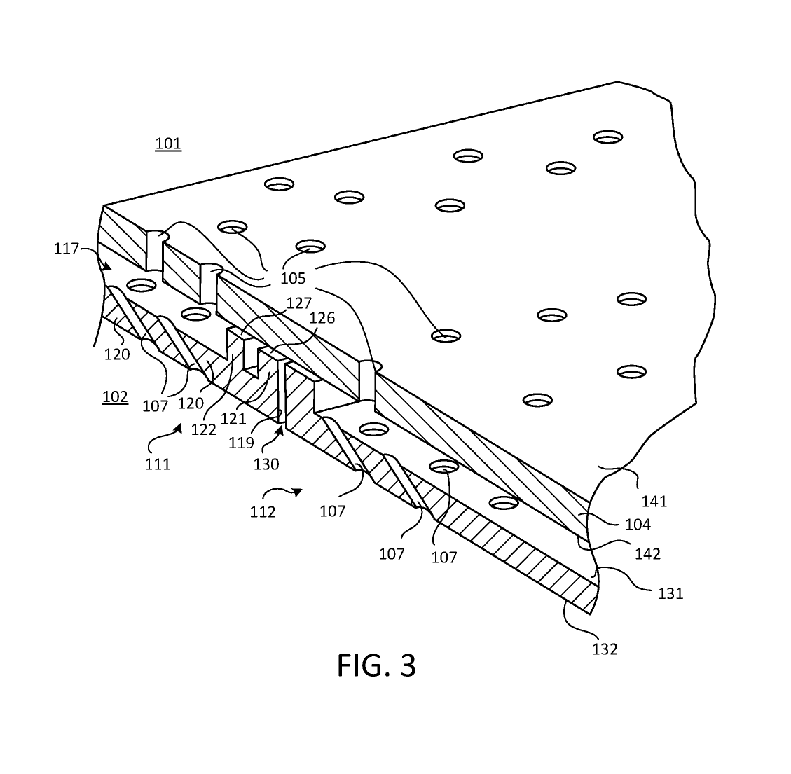

In various embodiments, and with reference to FIG. 3, an annular cooling cavity 117 is formed and/or defined between the combustor shell 104 and two adjacent combustor panels 110 (e.g., a first combustor panel 111 and a second combustor panel 112). As mentioned above, cooling air in the diffuser chamber 101 may enter the annular cooling cavity 117 via impingement holes 105 formed in the combustor shell 104. That is, impingement holes 105 may extend from a diffuser side 141 of the combustor shell 104 to a combustor side 142 of the combustor shell 104 and may supply cooling air to the annular cooling cavity 117. The cooling air in the annular cooling cavity 117 may enter the combustor chamber 102 via effusion holes 107 formed in the combustor panel. That is, effusion holes 107 may extend from a cooling surface or “cold side” 131 of the combustor panel to a combustion facing surface or “hot side” 132 of the combustor panel that is opposite the cold side 131. In various embodiments, the effusion holes 107 are generally oriented to create a protective “blanket” of air film over the hot side 132 of the combustor panel thereby protecting the combustor panel from the hot combustion gases in the combustor chamber 102.

In various embodiments, and with continued reference to FIG. 3, a channel 130 may be defined between adjacent combustor panels 111, 112. For example, the first combustor panel 111 may be a forward combustor panel and the second combustor panel 112 may be an aft combustor panel, wherein the channel 130 is an axial gap (e.g., the combustor panels 111, 112 are axially spaced apart from each other). In another example, the first combustor panel 111 and the second combustor panel 112 may be circumferentially adjacent each other, and the channel 130 may be a circumferential gap (e.g., the combustor panels 111, 112 may be circumferentially spaced apart from each other). The channel 130 may fluidly connect the annular cooling cavity 117 to the combustor chamber 102. Said differently, the cooling air may be configured to flow from the annular cooling cavity 117, through the channel 130, and into the combustor chamber 102.

As mentioned above, the high operating temperatures and pressure ratios of the combustion gases in the combustor section 26 may create operating environments that can damage various components of the combustor, such as the combustor panels, and thereby shorten the operational life of the combustor. The details of the present disclosure relate to a configuration of a combustor panel that, according to various embodiments, tends to prevent runaway oxidation (e.g., tends to prevent excessive “burnthrough”) of the combustor panel. The details of the present disclosure may be implemented in new gas turbine engines/combustors and/or may be implemented to repair, retrofit, and/or otherwise modify existing gas turbine engines/combustors.

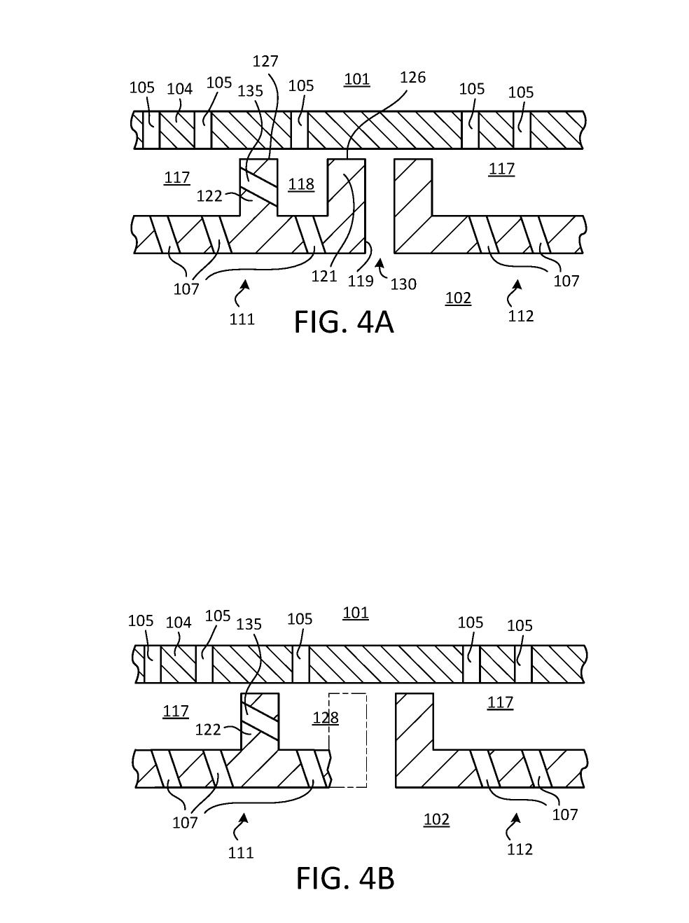

In various embodiments, and with continued reference to FIG. 3, the first combustor panel 111 has a body 120, a first endrail 121, and a second endrail 122. The first endrail 121 is disposed along an edge 119 of the body 120 and the second endrail 122 is disposed adjacent the first endrail 121, according to various embodiments. A gap/volume (118 with reference to FIG. 4A) is defined between the first endrail 121 and the second endrail 122. Thus, the first combustor panel 111 has redundant endrails 121, 122 protruding from the body 120 adjacent edge 119, according to various embodiments. Generally, the second endrail 122 tends to prevent rapid oxidation of the body 120 of the first combustor panel 111 in response to damage/oxidation of the first endrail 121, as described in greater detail.

The second endrail 122, according to various embodiments, extends substantially parallel to the first endrail 121 along the cold side 131 of the first combustor panel 111. In various embodiments, the second endrail 122 has the substantially same height as the first endrail 121. Said differently, the first endrail 121 has a first height, as measured as distance from the body 120 to a first tip 126 of the first endrail 121, the second endrail 122 has a second height, as measured as distance from the body 120 to a second tip 127 of the second endrail 122, and the first height is substantially the same as the second height, according to various embodiments. As used in this context only, the phrase “substantially the same height” means that the heights are within 10% of each other. Accordingly, the second endrail 122 is not just a minor rib that protrudes along the cold side 131 of the first combustor panel 111, but the second endrail 122 is similarly sized relative to the first endrail 121 and is configured to provide a redundant level of cooling air flow control, according to various embodiments. Conventional combustor panels that do not have a second, redundant endrail may experience rapid and exacerbated panel damage if the endrail is damaged (e.g., burnt away). That is, if a conventional combustor panel were to lose its only endrail, the cooling air flow in the annular cooling cavity would preferentially flow through the large area where the endrail was located instead of through the effusion holes, which would decrease effusion cooling to the panel and would result in rapid panel oxidation. However, according to various embodiments, the first combustor panel 111 disclosed herein, having redundant endrails 121, 122, maintains sufficient effusion cooling even in the event of damage/oxidation to the first endrail 121, as described in greater detail below with reference to FIG. 4B.

In various embodiments, the first endrail 121 is solid and has a continuous surface such that no cooling holes extend therethrough. In various embodiments, and with reference to FIGS. 4A and 4B, the second endrail 122 may define an endrail hole 135 extending through the second endrail 122. The endrail hole 135 may be configured to deliver cooing air flow to the volume 118 between the first endrail 121 and second endrail 122. The endrail hole 135 may have various cross-sectional shapes (e.g. circular, elliptical, obround, polygonal, etc.) and the endrail hole 135 may extend through the second endrail 122 at various orientations. For example, the endrail hole 135 may extend in a canted direction, relative to the first combustor panel 111, to provide impingement cooling and/or effusion cooling.

In various embodiments, a distance between the first endrail 121 and the second endrail 122 (e.g., a width of volume 118) is between about 0.05 inches (0.13 centimeters) and about 1.00 inch (2.54 centimeters). In various embodiments, the distance between the first endrail 121 and the second endrail 122 is between about 0.05 inches (0.13 centimeters) and about 0.50 inches (1.27 centimeters). In various embodiments, the distance between the first endrail 121 and the second endrail 122 is between about 0.10 inches (0.25 centimeters) and about 0.50 inches (1.27 centimeters). In various embodiments, the distance between the first endrail 121 and the second endrail 122 is between about 0.10 inches (0.25 centimeters) and about 0.40 inches (1.02 centimeters). As used in this context only, the term “about” means plus or minus 5% of the provided value.

In various embodiments, one or more impingement holes 105 in the combustor shell 104 may be aligned with and configured to deliver cooling air to the volume 118 between the first endrail 121 an the second endrail 122. In various embodiments, and with reference to FIGS. 3 and 4A, a distance between the first tip 126 of the first endrail 121 and the combustor side 142 of the combustor shell 104 is the same as a distance between the second tip 127 of the second endrail 122 and the combustor side 142 of the combustor shell 104. Said differently, a first gap between the first tip 126 of the first endrail 121 and the combustor shell 104 is substantially the same as a second gap between the second tip 127 of the second endrail 122 and the combustor shell 104.

Under nominal operating conditions, the pressure of cooling air within the volume 118 between the first and second endrails 121, 122 may be substantially the same as the pressure of cooling air within the annular cooling cavity 117. In response to damage/oxidation of the first endrail 121 (indicated by dashed lines in FIG. 4B), the pressure of the cooling air in the burnt away volume 128 would drop to be substantially the same as the pressure within the combustor chamber 102. As mentioned above, the presence of the second endrail 122 prevents the pressure in the annular cooling cavity 117 from rapidly falling, thereby maintaining a sufficient pressure gradient between the annular cooling cavity 117 and the combustor chamber 102 to enable proper effusion cooling of the first combustor panel 111 (e.g., via effusion holes 107).

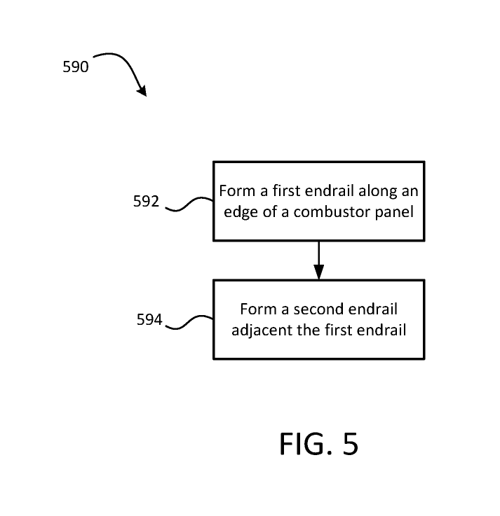

In various embodiments, and with reference to FIG. 5, a method 590 of manufacturing a combustor panel is provided. The method 590 may include forming a first endrail along an edge of a body of a combustor panel at step 592 and forming a second endrail adjacent the first endrail at step 594. Formation of the endrails at steps 592 and 594 may be by casting, additive manufacturing, or other procedures. Step 592 may include forming the first endrail so that it has a first height, as measured as a distance from the body of the combustor panel to a first tip of the first endrail and step 594 may include forming the second endrail so that it has a second height, as measured as a distance from the body of the combustor panel to a second tip of the second endrail, wherein the first height and the second height are the same. According to various embodiments, the method 590 may include coupling the combustor panel to a combustor shell such that respective distances between the respective tips of the endrails and the combustor shell is the same. The method 590 may further include forming an endrail hole extending through the second endrail.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure.

The scope of the disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. All ranges and ratio limits disclosed herein may be combined.

Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

Any reference to attached, fixed, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts or areas but not necessarily to denote the same or different materials. In some cases, reference coordinates may be specific to each figure.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A combustor panel comprising:
a body comprising an edge;
a first endrail disposed along the edge of the body; and
a second endrail disposed adjacent the first endrail, wherein a gap is defined between the first endrail and the second endrail.

2. The combustor panel of claim 1, wherein the first endrail has a first height, measured from the body to a first tip of the first endrail, and the second endrail has a second height, measured from the body to a second tip of the second endrail, wherein the first height is substantially the same as the second height.

3. The combustor panel of claim 1, wherein the second endrail defines an endrail hole extending through the second endrail.

4. The combustor panel of claim 3, wherein the endrail hole is canted relative to the combustor panel.

5. The combustor panel of claim 3, wherein the first endrail is solid and has a continuous surface.

6. The combustor panel of claim 1, wherein a distance between the first endrail and the second endrail is between about 0.05 inches and about 1.0 inch.

7. The combustor panel of claim 1, wherein a distance between the first endrail and the second endrail is between about 0.10 inches and about 0.50 inches.

8. A combustor of a gas turbine engine, the combustor comprising:
a combustor shell; and
a combustor panel coupled to the combustor shell, the combustor panel comprising:
a body comprising an edge;
a first endrail disposed along the edge of the body; and
a second endrail disposed adjacent the first endrail, wherein a gap is defined between the first endrail and the second endrail.

9. The combustor of claim 8, wherein the first endrail has a first height, measured from the body to a first tip of the first endrail, and the second endrail has a second height, measured from the body to a second tip of the second endrail, wherein the first height is substantially the same as the second height.

10. The combustor of claim 8, wherein an annular cooling cavity is defined between the combustor shell and the combustor panel, wherein a first gap between a first tip of the first endrail and the combustor shell is substantially the same as a second gap between a second tip of the second endrail and the combustor shell.

11. The combustor of claim 8, wherein the second endrail defines an endrail hole extending through the second endrail.

12. The combustor of claim 11, wherein the endrail hole is canted relative to the combustor panel.

13. The combustor of claim 12, wherein the first endrail is solid and has a continuous surface.

14. The combustor of claim 8, wherein a distance between the first endrail and the second endrail is between about 0.05 inches and about 1.0 inch.

15. The combustor of claim 8, wherein a distance between the first endrail and the second endrail is between about 0.10 inches and about 0.50 inches.

16. The combustor of claim 8, wherein an impingement hole of the combustor shell is configured to deliver cooling air to a volume between the first endrail and the second endrail.

17. The combustor of claim 8, wherein the combustor panel is a first combustor panel, wherein the combustor further comprises a second combustor panel coupled to the combustor shell adjacent the first combustor panel.

18. A method of manufacturing a combustor panel, the method comprising:
forming a first endrail along an edge of a body of the combustor panel; and
forming a second endrail adjacent the first endrail.

19. The method of claim 18, wherein the first endrail has a first height, measured from the body to a first tip of the first endrail, and the second endrail has a second height, measured from the body to a second tip of the second endrail, wherein the first height is substantially the same as the second height.

20. The method of claim 18, further comprising forming an endrail hole extending through the second endrail.
